(19) United States
(12) Patent Application Publication
(10) Pub. No.: US 2022/0223327 A1
(43) Pub. Date: Jul. 14, 2022

(54) Filter Element and Arrangement for Fastening a Filter Element

(71) Applicant: TDK Electronics AG, Munich (DE)

(72) Inventors: Fabian Beck, Rüttenen (CH); Barnabas Kiss, Vassurany (HU)

(21) Appl. No.: 17/614,241

(22) PCT Filed: Apr. 29, 2020
(86) PCT No.: PCT/EP2020/061889

§ 371 Date: Nov. 24, 2021

(30) Foreign Application Priority Data
Jun. 17, 2019 (DE) 10 2019 116 362.5

(51) Int. Cl. H01F 17/06; H02M 7/00; H01F 27/02; H01F 27/30

(52) U.S. Cl. CPC H01F 17/06; H02M 7/003; H01F 2017/065; H01F 27/306; H01F 27/02

(57) ABSTRACT

In an embodiment, a filter element includes at least one magnetic core accommodated in a housing and at least one fastening element arranged on the housing, wherein the fastening element is configured to connect the filter element directly to a current-conducting element, and wherein the filter element is configured to filter an interference signal.

This patent application is a national phase filing under section 371 of PCT/EP2020/061889, filed Apr. 29, 2020, which claims the priority of German patent application 102019116362.5, filed Jun. 17, 2019, each of which is incorporated herein by reference in its entirety.

### TECHNICAL FIELD

The present invention relates to a filter element for filtering an interference signal, in particular an EMI (electromagnetic interference) filter element. The present invention relates further to an arrangement for fastening a filter element to a current-conducting element, for example a busbar.

### BACKGROUND

Busbars are typically used for the electrical connection of rectifier applications with a phase current >100 A. At the input of the rectifier there is generally arranged an EMI filter element, which comprises inter alia capacitors and toroidal cores for compensating interference currents (so-called common mode toroidal cores).

The components of the filter element must generally be arranged in the specified volume around the busbars at the current input of the rectifier. However, the available space at the input of the rectifier for the installation of the filter element is very limited.

For the mechanical fixing of the magnetic core, side plates on the plastics casing of the magnetic core are normally used, via which side plates the core is fastened alongside the busbars. However, this has the negative effect that a large amount of space on the side of the core next to the busbars is lost as a result of the side plates.

### SUMMARY

Embodiments provide a filter element and an arrangement for fastening a filter element which have improved properties.

According to one embodiment, a filter element is described. The filter element is configured to filter an interference signal. The filter element is preferably an EMI filter.

The filter element is configured to ensure a stable power supply for electronic devices, for example for a rectifier, in a high-temperature environment. The components of the filter element should still be reliably usable at temperatures above 85° C. For example, the components are usable at least up to a temperature of 125° C., preferably at least up to 150° C. The filter element is preferably used in electric vehicles.

The filter element has at least one magnetic core. The core is preferably a common mode core. The core is configured to compensate interference currents. The core is accommodated in a housing. The core is surrounded completely by the housing. Preferably, the housing comprises plastics material. Particularly preferably, the housing is produced entirely from plastics material.

The filter element further has at least one fastening means, preferably at least two fastening means. For example, the filter element has four fastening means. The fastening means is arranged on the housing. Preferably, in each case at least one fastening means is formed on a side or side face of the housing. In this case, the fastening means are formed on opposite side faces of the housing.

The at least one fastening means is configured and arranged to connect the filter element directly to a current-conducting element. In other words, direct mechanical contact and a direct mechanical connection between the filter element, in particular the magnetic core, and the current-conducting element is to be made possible by means of the fastening means.

This results in a very compact construction of the filter element. Space-saving installation of the magnetic core and of the filter element as a whole, for example at the input of a rectifier, is thus made possible.

In one embodiment, the at least one fastening means is formed in one piece with the housing. For example, the housing has at least two housing parts. In this case, at least one fastening means can be formed in one piece with a housing part. For example, the fastening means and the housing or the housing part are produced in a common injection molding step. The fastening means can thus be formed on the housing in a simple and inexpensive manner.

In one embodiment, the fastening means increases a width of the housing, or of the magnetic core. The width of the housing, or of the core is thereby defined by a transverse axis of the housing, along which the current-conducting element, for example a busbar, is guided through the magnetic core and in particular through an opening of the housing, or of the core. The transverse axis is perpendicular to a longitudinal axis of the housing, or of the core. As a result, the fastening means makes use of space that is in any case present or already used transversely to the longitudinal axis of the housing, or along the feed-through direction of the current-conducting element.

Additional fastening means which must be arranged next to the current-conducting element are not required. A compact filter element is thus provided and space-saving installation of the magnetic core, or of the filter element, is made possible.

In one embodiment, the at least one fastening means has a web portion on a side flank or side face of the housing. The fastening means is formed along the longitudinal axis, consequently along a long side face, of the housing. The long side face of the housing extends perpendicularly to the feed-through direction of the current-conducting element. As a result, a compact construction of the filter element is achieved and at the same time simple orientation of the filter element to the busbars is made possible.

In one embodiment, the at least one fastening means has at least one fastening element, for example a screw, a rivet or a plastics pin. The fastening means can further have at least one recess, or an aperture, for the passage of the fastening element. A simple and stable connection of the filter element to the current-conducting element is thus made possible. Furthermore, at the same time joint orientation of the filter element and of the current-conducting element is thereby made possible.

In one embodiment, the at least one fastening means is configured to be connected to the current-conducting element by adhesive bonding, press-fitting or clamping. The above-described fastening elements and/or recesses of the fastening means can thereby be omitted. For example, the fastening means is configured to be connected to the current-conducting element by hot press-fitting, for example by a particularly flat surface and/or by additional web portions extending along a side edge of the fastening means. In the case of clamping too, additional surface structures can be provided on a surface of the fastening means, for example protrusions and/or web portions which facilitate a clamped connection with the current-conducting element.

A simple and stable connection between the filter element and the current-conducting element is thus made possible, which in particular requires a small number of components for connecting the filter element and the current-conducting element. Accordingly, a particularly inexpensive and compact filter element is provided.

According to a further embodiment, an arrangement for fastening a filter element to a current-conducting element is described. The arrangement has a filter element for filtering an interference signal, for example the filter element described above. All the features which have been explained in connection with the filter element described above are also applicable to the arrangement described hereinbelow and vice versa.

The arrangement has at least one busbar, preferably two busbars. The busbars preferably extend parallel to one another. In normal operation, the nominal current flows through the busbars in opposite directions.

The filter element has at least one magnetic core. The magnetic core is configured to compensate interfering currents that occur (common mode core). The magnetic core is accommodated in a housing and preferably surrounded completely by the housing. Preferably, the housing comprises plastics material. Particularly preferably, the housing is manufactured entirely of plastics material, for example by means of an injection molding process.

The housing, or the core has an opening. The opening is a through-opening. The at least one busbar is guided through the opening along a transverse axis of the core, or of the housing.

The filter element has at least one fastening means, preferably two or four fastening means. The fastening means is configured and arranged to connect the filter element directly to the at least one busbar. Preferably, the fastening means lies directly on a surface of the busbar. Preferably, a fixed mechanical connection between the magnetic core—and thus the filter element as a whole—and the busbar is established by the fastening means.

As a result, compact fastening of the filter element directly to the busbars, which are in any case present, is achieved. Additional space in a side region next to the busbars for the fastening of the filter element is not required. Furthermore, the filter element and the busbars are oriented in a simple manner.

In one embodiment, the at least one fastening means has a web portion on the housing. The fastening means can further have a recess, preferably an aperture. The fastening means can further have a fastening element, such as, for example, a screw or a rivet or a plastics pin. The fastening element is in this case introduced into the recess in order to connect the magnetic core directly to the busbar.

The busbar preferably has at least one receiving device, for example a threaded bush or a protrusion. The receiving device is preferably provided on an outer surface of the busbar. The receiving device can extend into an inner region of the busbar.

The receiving device is configured for fastening the fastening element to the busbar. Preferably, the receiving device and the fastening means are in direct mechanical interplay with one another. In this manner, a stable and durable connection between the filter element and the busbar is achieved.

In one embodiment, the at least one fastening means is connected to the busbar by adhesive bonding, press-fitting or clamping. For example, the fastening means and the busbar are connected together by hot press-fitting. In this manner, the number of components of the filter element can be reduced. As a result, a particularly compact and inexpensive filter element and a very compact arrangement can be provided.

In one embodiment, the fastening means is formed on the housing in such a manner that an extent of the magnetic core in the feed-through direction of the busbar is increased. As a result, space that is in any case required by the busbars is used for the fastening of the filter element. Additional space for the installation of the filter element no longer has to be made available. The filter element can thus be integrated in a particularly space-saving manner, for example in an electric vehicle.

### BRIEF DESCRIPTION OF THE DRAWINGS

The drawings described hereinbelow are not to be interpreted as being true to scale. Rather, for the purpose of better illustration, individual dimensions can be increased, reduced or also represented in a distorted manner.

Elements which are the same as one another or which perform the same function are designated by the same reference numerals.

FIG. 1a is a schematic top view of an arrangement for fastening a filter element according to the prior art;

FIG. 1b is a schematic side view of the arrangement for fastening a filter element according to FIG. 1a;

FIG. 2a is a schematic top view of an arrangement for fastening a filter element;

FIG. 2b is a schematic side view of the arrangement for fastening a filter element according to FIG. 2a;

FIG. 3 is a perspective view of a magnetic core of a filter element; and

FIG. 4 is a perspective top view of the magnetic core according to FIG. 3.

### DETAILED DESCRIPTION OF ILLUSTRATIVE EMBODIMENTS

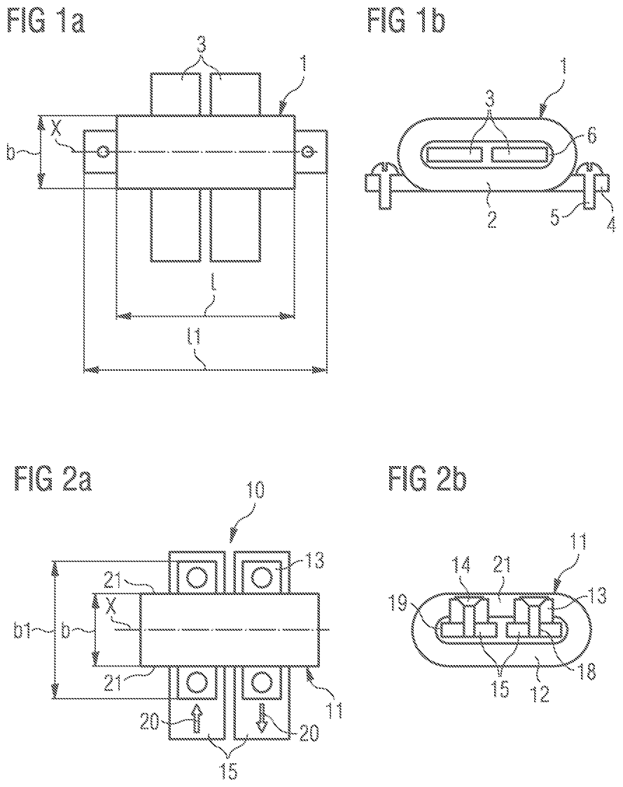

FIGS. 1a and 1b show a schematic view of an arrangement for fastening a filter element according to the prior art.

The filter element is an EMI filter. An EMI filter generally has a plurality of components, for example a magnetic core 1 and one or more capacitors. For the sake of simplicity, the filter element is described in the following only as the magnetic core 1.

The core 1 is introduced into a plastics housing 2. The housing 2 has an elliptical opening 6, through which two busbars 3 are guided. The busbars 3 are guided through the core 1 perpendicularly to a longitudinal axis x of the housing 2. The core 1 is consequently arranged around the busbars 3, for example at the input of a rectifier. There is thereby no direct contact between the core 1 and the busbars 3, as is apparent from FIG. 1b.

For the mechanical fixing of the filter element, the housing 2 has two side plates 4 which are arranged on opposite side flanks, in particular on the opposite narrow sides, of the housing 2. A recess is introduced into each side plate 4, through which recess a screw 5 is guided for fastening the filter element to a printed circuit board (not explicitly shown), for example.

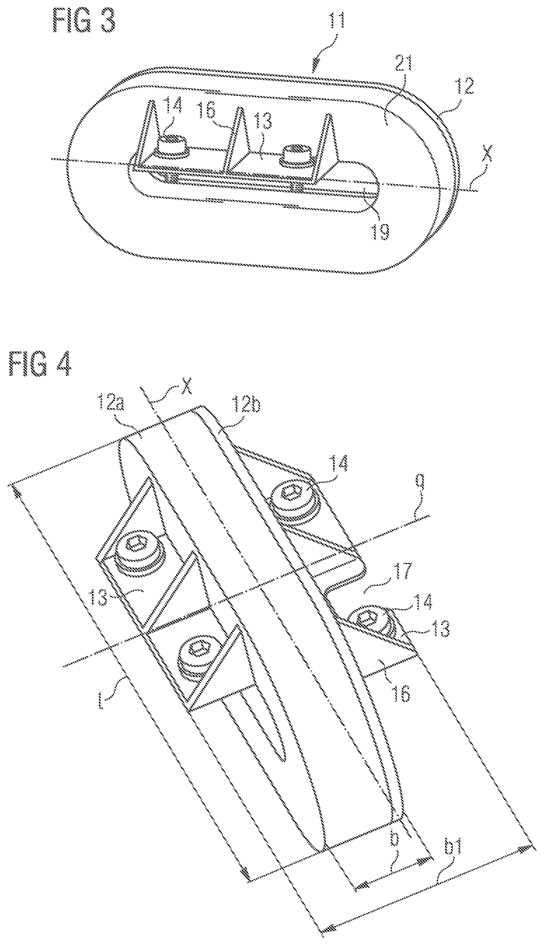

By means of the side plates 4, an extent of the housing 2 along the longitudinal axis x (longitudinal extent of the housing 2 or of the core 1) is increased. The housing 2 without the side plates 4 has a length 1 (FIG. 1a). The housing 2 with the side plates 4 has a length l₁, wherein l₁>l. An extent of the housing 2 along a transverse axis q (see FIG. 4) which extends perpendicularly to the longitudinal axis x (width of the housing 2 or of the core 1), on the other hand, is not affected by the side plates 4.

The fastening of the filter element by means of the side plates 4 has the negative effect that a large amount of space is required alongside the core 1 for installation.

FIGS. 2a and 2b show a schematic view of an arrangement for fastening a filter element to a current-conducting element.

The filter element is an EMI filter, preferably a high-temperature EMI filter. In particular, the filter element is configured to ensure a stable power supply for electronic devices, for example for a rectifier, in a high-temperature environment. In a high-temperature environment, high thermal stability of the filter element is required. The components of the filter element should still be reliably usable at temperatures above 85° C. For example, the components are usable at least up to a temperature of 125° C., preferably at least up to 150° C. The filter element is preferably used in electric vehicles.

The EMI filter has a plurality of components, for example a magnetic core 11 and one or more capacitors (not shown explicitly). The magnetic core 11 is a so-called common mode core. That is to say, the magnetic core 11 is so configured that, under operating current, the inductance of the core 11 is compensated. For example, the inductance of the core 11 under operating current is 0.1%. In the common mode interference mode, on the other hand, the core 11 has full inductance.

The core 11 preferably comprises a soft magnetic material. The material can comprise, for example, ferrite, a manganese-zinc (MnZn) compound, a nickel-zinc (NiZn) compound or a nanocrystalline material. In this exemplary embodiment, the material is shown in an ellipse shape.

The core 11 is accommodated in a housing 12. The core 11 is surrounded completely by the housing 12. The housing 12 preferably comprises plastics material. The housing 12 is preferably produced by means of an injection molding process. In this exemplary embodiment, the housing 12 is elliptical. However, other forms are also conceivable, for example an angular housing 12. The housing 12 has an inner opening 19, in this case an elliptical opening 19. The opening 19 passes through the housing 12 completely.

Two busbars 15 are guided through the opening 19, as is apparent from FIG. 2a. In the operating mode, the current flows through the busbars 15 in opposite directions. This is represented by the two arrows 20 in FIG. 2a.

The busbars 15 are guided through the core 11 or through the housing 12 perpendicularly to a longitudinal axis x of the housing 12. The core 11 is arranged around the busbars 15, for example at the input of a rectifier. Preferably, the at least one capacitor of the filter element is arranged on one of the busbars 15 (not shown explicitly). The at least one capacitor of the filter element is preferably arranged between the core 11 and the busbars 15.

For the mechanical fastening of the filter element, the housing 12 in this exemplary embodiment has four fastening means 13. Each fastening means 13 is formed on a side flank or side face 21 of the housing 12. In particular, in the representation shown in FIGS. 2a and 2b, two fastening means 13 are formed on each of two opposite side flanks 21 of the housing 12. It will clearly be seen that a fastening means 13 is in each case arranged directly above a busbar 15 along the opposite side flanks 21 of the housing 12. In other words, in this exemplary embodiment one fastening means 13 per side flank 21 is associated with exactly one busbar 15.

Unlike in the filter element shown in FIGS. 1a, 1b, each fastening means 13 is formed on a longitudinal side of the housing 12. In other words, each fastening means 13 is formed on the side face or side flank 21 of the housing 12 that extends along the longitudinal axis x of the housing 12 or of the core 11.

In this exemplary embodiment, each fastening means 13 is formed on the upper side flank 21 of the housing 12, that is to say above the opening 19, which can clearly be seen in the cross-section of FIG. 2b. It is, however, also conceivable that each fastening means 13 is formed on the lower side flank 21 of the housing 12, that is to say beneath the opening 19. In other words, the fastening means 13 do not necessarily have to be formed above the busbars 15. For example, the fastening means 13 can also be formed on the housing 12 in such a manner that they extend beneath the busbars 15.

Further conceivable are also only three, two or one fastening means 13. For example, the two fastening means 13 shown in FIGS. 2a, 2b can be formed on one side flank 21 as a continuous fastening means 13 (see in this connection FIGS. 3 and 4).

Each fastening means 13 is in the form of a web portion. The fastening means 13 projects from the side flank 21 of the housing 12. The housing 12 and the fastening means 13 are preferably formed in one piece. Preferably (see in this connection FIG. 4), the housing 12 has two housing parts 12a, 12b. Preferably at least one fastening means 13 is thereby formed in one piece with a housing part 12a, 12b.

By means of the fastening means 13, direct mechanical contact between the housing 12 and the busbars 15 is established. The fastening means 13 lies at least in part directly on at least one busbar 15 (FIG. 2b).

For the mechanical fixing of the filter element, each fastening means 13 in the exemplary embodiment shown has a recess 18. The recess 18 is a through-recess. The fastening means 13 further has at least one fastening element 14. The recess 18 serves for the passage of the fastening element 14, for example a screw, a plastics pin or a rivet (e.g. a plastics plug).

By means of the fastening element 14, the housing 12 is mechanically connected directly to the busbars 15. For receiving the fastening element 14, each busbar 15 has a corresponding receiving device (not shown explicitly). For example, a threaded bush can be let into a surface of the busbar 15. Alternatively, a recess can be provided on a surface of the busbar 15, for example for receiving a rivet.

In an alternative exemplary embodiment (not shown explicitly), the fastening means 13 can also be connected directly to the respective busbar 15 by adhesive bonding, clamping or press-fitting, for example by means of hot press-fitting.

By means of the at least one fastening means 13, an extent of the housing 12 perpendicularly to the longitudinal axis x (width of the housing 2 or of the core 11) is increased. The housing 12 without the fastening means 13 has a width b. The housing 12 with the fastening means 13 has a width b₁, wherein b₁>b. In other words, an extent of the housing 12 in the feed-through direction of the busbars 15 is increased by the fastening means 13.

An extent of the housing 12 along the longitudinal axis x (length 1 of the housing 12 or of the core 11, FIG. 4), on the other hand, is not affected by the fastening means 13. As a result, space that is already present along the busbars 15 is used for the fastening of the filter element.

The filter element is consequently particularly compact and space-saving. Furthermore, the busbars 15 are also fastened in a simple manner by the fastening means 13, without the need for further fastening elements. In addition, the fastening means 13 also serves to orient the busbars 13 and the filter element.

FIG. 3 shows a perspective view of an exemplary embodiment of the core 11. It will be seen therein that the fastening means 13 is formed on the side flank 21 in such a manner that it is directly adjacent to the opening 19 through which the busbars 15 are guided. The fastening elements 14, which in this exemplary embodiment are screws, project at least partially into the opening 19 for the mechanical connection of the core 11 to the busbars 15.

Perpendicularly to the longitudinal axis x, three web portions 16 on a surface of the fastening means 13 extend along the housing 12. These are each in the form of a triangle and serve to mechanically stabilize the fastening means 13. In an alternative exemplary embodiment, the web portions 16 can also be omitted or only one or two web portions 16 can be present.

Furthermore, in FIG. 3 only one fastening means 13 is formed on the upper side flank 21 of the housing 12. The fastening means 13 has a greater extent along the longitudinal axis x than the respective fastening means 13 of FIGS. 2a, 2b. In this exemplary embodiment, the fastening means 13 extends over both busbars 15. In other words, in this case only one fastening means 13 is provided on a side flank 21 for mechanical connection to both busbars 15.

A further fastening element 13 is formed on the opposite side flank 21 (on the rear side in FIG. 3) of the housing 12. It would, however, also be conceivable for the further fastening element 13 to be omitted and for the core 11 to be fastened to the busbars 15 by means of only a single fastening element 13.

FIG. 4 is a perspective top view of an exemplary embodiment of the core 11.

As already described in connection with FIGS. 2a and 2b, the housing 12 has two housing parts 12a, 12b, wherein a fastening means 13 is formed on each housing part 12a, 12b. The respective housing part 12a, 12b is formed in one piece with the respective fastening means 13.

One of the two fastening means 13 has an indentation or recess 17. The indentation 17 is formed on the fastening means 13 in such a manner that it is arranged directly above one of the two busbars 15. In particular, the indentation 17 is not arranged in the middle of the fastening means 13 but is displaced towards one side or towards one fastening element 14. For example, the indentation 17 is punched or milled into the fastening means 13.

The indentation 17 serves to establish electrical contact with the busbar 15 located beneath it. Preferably, at least one capacitor (not shown explicitly) is arranged between the core 11 and the busbar 15. In particular, the at least one capacitor is arranged between the fastening means 13 and the busbar 15. The indentation 17 is configured for electrical contacting of the capacitor.

The description of the subject-matter provided here is not limited to the individual specific embodiments. Rather, the features of the individual embodiments—where technically expedient—can be combined with one another as desired.

1.-15. (canceled)

16. A filter element comprising:
at least one magnetic core accommodated in a housing; and
at least one fastening element arranged on the housing,
wherein the fastening element is configured to connect the filter element directly to a current-conducting element, and
wherein the filter element is configured to filter an interference signal.

17. The filter element as claimed in claim 16, wherein the at least one fastening element is formed in one piece with the housing.

18. The filter element as claimed in claim 16, wherein the fastening element increases a width of the housing, and wherein the width of the housing is defined by a transverse axis of the housing along which the current-conducting element is guided through the magnetic core.

19. The filter element as claimed in claim 16, wherein the at least one fastening element has a web portion on a side flank of the housing, and extends along a longitudinal axis of the housing.

20. The filter element as claimed in claim 16, wherein the at least one fastening element has at least one fastening component, and wherein the fastening component has at least one recess for a passage of the fastening component.

21. The filter element as claimed in claim 20, wherein the fastening component comprises a screw, a rivet or a plastic pin.

22. The filter element as claimed in claim 16, wherein the at least one fastening element is configured to be connected to the current-conducting element by adhesive bonding, press-fitting or clamping.

23. The filter element as claimed in claim 16, wherein the filter element comprises at least two fastening elements.

24. The filter element as claimed in claim 23, wherein the housing has at least two housing parts, and wherein at least one fastening element is formed in one piece with each housing part.

25. An arrangement comprising:
a filter element configured to filter an interference signal; and
at least one busbar,
wherein the filter element has at least one magnetic core accommodated in a housing,
wherein the at least one busbar is guided along a transverse axis of the magnetic core through an opening of the magnetic core, and
wherein the filter element comprises at least one fastening element configured to connect the filter element directly to the at least one busbar.

26. The arrangement as claimed in claim 25, wherein the at least one fastening element has a web portion on the housing, wherein at least one recess is provided in the fastening element, and wherein a fastening component is introduced into the recess for directly connecting the magnetic core to the busbar.

27. The arrangement as claimed in claim 26, wherein the at least one busbar has at least one receiving device, and wherein the receiving device is configured to fasten the fastening component to the busbar.
$$E PC - 637 - EH \qquad Page 4 of 6$$

28. The arrangement as claimed in claim 27, wherein the receiving device has a thread and/or wherein the receiving device has a recess on an outer surface of the busbar.

29. The arrangement as claimed in claim 25, wherein the at least one fastening element is connected to the busbar by adhesive bonding, press-fitting or clamping.

30. The arrangement as claimed in claim 25, wherein the fastening element is formed on the housing in such a manner that an extent of the magnetic core along a feed-through direction of the busbar is increased.
